(19) United States
(12) Patent Application Publication
(10) Pub. No.: US 2026/0077744 A1
(43) Pub. Date: Mar. 19, 2026

(54) SENSOR MODULE WITH ENVIRONMENTAL SENSOR AND A CLEANING NOZZLE

(71) Applicant: Webasto SE, Stockdorf (DE)

(72) Inventors: Cédric LANGLAIS, Hengersberg (DE); Nikolaus LINNER, Stockdorf (DE)

(21) Appl. No.: 19/328,809

(22) Filed: Sep. 15, 2025

(30) Foreign Application Priority Data
Sep. 19, 2024 (DE) 102024126989.8

(51) Int. Cl. B60S 1/56; B60S 1/52; B60S 1/54; G01S 7/02; G01S 7/40; G01S 7/481; G01S 7/497; G01S 7/52

(52) U.S. Cl. CPC B60S 1/56; B60S 1/52; B60S 1/54; G01S 7/027; G01S 7/4043; G01S 7/4813; G01S 7/497; G01S 7/52004; G01S 7/52079; G01S 2007/4977; G01S 2007/52011

(57) ABSTRACT

A sensor module for a motor vehicle is proposed, having: a surface component with an opening, a sensor housing with a see-through area which is arranged in the opening so that it can be adjusted between a retracted position and an extended position; an environment sensor which can capture a vehicle environment through the see-through area at least in the extended position, and which is arranged in the sensor housing a seal mounting frame which is arranged in the region of the opening; at least one seal which is arranged on the seal mounting frame or is formed by the latter, and by means of which an intermediate space between the opening and the sensor housing can be sealed, wherein the seal mounting frame has at least in some sections a cleaning nozzle for cleaning the see-through area.

### CROSS-REFERENCE TO RELATED APPLICATION

This application claims the benefit of German Application No. 102024126989.8, filed Sep. 19, 2024, which is incorporated herein by reference in its entirety.

### TECHNICAL FIELD

The invention relates to a sensor module with an adjustable environment sensor and a cleaning nozzle. The invention moreover relates to a motor vehicle which comprises at least one such sensor module.

### BACKGROUND

Vehicle roofs are known in practice. A vehicle roof can be designed, for example, as a roof sensor module which can be placed as a separate component on a vehicle body, forming a vehicle bodyshell, of a car. As an interface with the vehicle roof, the vehicle body comprises roof posts which can take the form of longitudinal posts and/or transverse posts and constitute a support system on the vehicle bodyshell. The vehicle roof comprises a roof skin which forms an outer visible surface and has sensor viewing regions through which the environment sensors, which serve to capture a vehicle environment and are arranged underneath the roof skin, can capture the vehicle environment.

Self-driving or partially self-driving vehicles comprise, for example, a roof designed as a roof sensor module (RSM) which is equipped with a plurality of environment sensors. The environment sensors, which are integrated in a dry region into the vehicle roof designed in particular as a roof sensor module and which are designed, for example, as lidar sensors and/or as radar sensors and/or as cameras, capture the environment around the vehicle and make corresponding measurement signals available to control electronics of the relevant vehicle such that a respective traffic situation can be identified and the driving behavior of the relevant vehicle can be adapted to this traffic situation. The environment sensors can here be arranged, for example, retractably and extendably or rigidly on the roof skin.

In order to enable as fault-free capturing of the vehicle surroundings as possible, it is known to keep a viewing region, through which the environment sensor looks in order to capture the vehicle environment, free of optical interference such as drops of water and/or particles of dirt. The viewing region can be formed either directly on the environment sensor and, for example, in the form of a lens or, alternatively or additionally, the viewing region can also be provided in a cover of the environment sensor which can be part of a sensor housing or another body part.

Various cleaning devices are known for cleaning the viewing region. The cleaning can be effected, for example, by means of compressed air or by another cleaning fluid. Moreover, mechanical cleaning devices such as wipers or the like are known but these are often configured technically in a very complex fashion.

In the case of adjustable or movable environment sensors, a seal is required between an edge region of an opening in which the environment sensor is arranged adjustably and the sensor housing in order to prevent the penetration of water into an inner region of the sensor module or of the motor vehicle. Cleaning nozzles should be positioned as close as possible to the viewing region for the cleaning of the viewing region. The cleaning nozzles can here either be arranged on the movable sensor housing or integrated into the latter. Arrangement or integration of this type is, however, technically complex because, for example, tubes and the like have to be installed in such a way that they can retract and extend with the environment sensor. It is therefore alternatively possible to place the cleaning nozzles in a surface component in front of the environment sensor, i.e. in front of the edge region. However, this results in a larger distance between the cleaning nozzles and the viewing region, which is disadvantageous for the effectiveness of the cleaning power. This arrangement also has disadvantages from a design point of view.

### SUMMARY

The object of the invention is to provide an improved sensor module.

The object is achieved by a sensor module sensor module having a surface component with an opening, a sensor housing with a see-through area which is arranged in the opening so that it can be adjusted between a retracted position and an extended position; an environment sensor which can capture a vehicle environment through the see-through area at least in the extended position, and which is arranged in the sensor housing; a seal mounting frame which is arranged in the region of the opening; at least one seal which is arranged on the seal mounting frame or is formed by the latter, and by means of which an intermediate space between the opening and the sensor housing can be sealed, wherein the seal mounting frame has at least in some sections a cleaning nozzle for cleaning the see-through area.

Advantageous embodiments of the invention are the subject of the dependent claims. All combinations of at least two features disclosed in the description, the claims, and/or the Figures fall within the scope of the invention. It is understood here in particular that customary linguistic variants and/or the analogous replacement of respective concepts as part of customary linguistic practice, in particular the use of synonyms supported by the generally accepted linguistic literature, are comprised by the content disclosed in this document without their respective formulation being explicitly mentioned.

In a first aspect, a sensor module is proposed for a motor vehicle. The sensor module has a surface component with an opening, a sensor housing with a see-through, e.g., transparent, area (viewing region) which is arranged in the opening so that it can be adjusted between a retracted position and an extended position, an environment sensor which can capture a vehicle environment through the see-through area at least in the extended position, and which is arranged in the sensor housing, a seal mounting frame which is arranged in the region of the opening, at least one seal which is arranged on the seal mounting frame or is formed by the latter, and by means of which an intermediate space between the opening and the sensor housing can be sealed, wherein the seal mounting frame has at least in some sections a cleaning nozzle for cleaning the see-through area.

The cleaning nozzle is preferably a (compressed) air cleaning nozzle which is designed to clean the see-through area by means of a gaseous cleaning fluid. Alternatively, the cleaning nozzle can also be operated with a different cleaning fluid, for example water or a soap solution. The cleaning nozzle is preferably formed with a strip shape. The cleaning nozzle preferably comprises a slit-shaped discharge opening through which the cleaning fluid can be applied to the see-through area. Because the cleaning nozzle in the present case can be arranged on the seal mounting frame or be formed by the latter at least in some sections, placement of the cleaning nozzle in the immediate vicinity of the see-through area is possible. As a result, the distance between the cleaning nozzle and the see-through area is reduced to a minimum, as a result of which the cleaning effect is optimized. The cleaning nozzle can thus be placed directly at the opening, in particular in an edge region of the opening, or in the intermediate space between the edge region of the opening and an outer surface of the sensor housing or of the see-through area.

An outlet opening of the cleaning nozzle, which can in particular be formed as slit-shaped, can thus be placed very close to the see-through area. The seal mounting frame moreover offers different options for fastening the at least one seal. The seal mounting frame can optionally be formed as a two-component injection-molded part in order thereby to make complex geometries possible. The proposed solution has fewer parts, as a result of which the costs are reduced. The mounting is moreover less complex, as a result of which a saving can be made in labor time and costs. The proposed solution likewise affords more freedom in terms of tolerances such that less precise mounting is necessary with a constant sealing and cleaning capacity. An optical appearance is also improved by the present roof module.

The seal mounting frame can be fastened to the surface component. Alternatively, the seal mounting frame can also be fastened to a sensor module frame or a body part of the motor vehicle.

In a preferred embodiment, the seal mounting frame can be used as a carrier for further components of a cleaning device, in particular for air lines and/or connectors and/or valves. Alternatively, it is also possible that the seal mounting frame integrally forms some parts of the cleaning device, in particular air lines and/or connectors and/or valves.

It should be understood that the sensor module can have at least one environment sensor. It should be understood that the sensor module can have at least one cleaning nozzle. It should be understood that the sensor module can have further functional components, in particular an air-conditioning device for air-conditioning the environment sensor and/or a lighting device and/or other cleaning components.

Functional components of this type can be arranged on the sensor module frame. The environment sensor can have a lidar sensor and/or a radar sensor and/or an ultrasound sensor and/or an infrared sensor and/or a camera sensor.

In a further aspect, it is proposed that the seal mounting frame forms the cleaning nozzle at least in some sections, in particular integrally, or wherein the cleaning nozzle is formed by an insert which is arranged or inserted or pushed in at least in some sections on the seal mounting frame.

The seal mounting frame can be formed from a plastic or another material and serve to hold or fasten the seal. However, the seal mounting frame does not necessarily have to be designed as stiff and instead can also be formed, for example, from vulcanized rubber or natural rubber or another sealing material, and thus in particular also be elastic. A stiffness of the seal mounting frame can be provided, for example, also by an insert or the like which can be used as a stiffening means, and such an insert can, for example, form the cleaning nozzle or comprise the latter. In order to improve the resistance to a pressure inside the cleaning nozzle, a further insert can moreover be provided which can be integrated into the seal mounting frame or into the seal. Such a further insert can also serve as a type of strengthening plate. Such a further insert can moreover also function as a sealing foot or the like.

In a further aspect, it is proposed that the seal mounting frame borders an edge region of the opening at least in some sections, preferably completely.

Particularly preferably, the seal mounting frame comprises the opening completely such that the seal can be formed, for example, as a sealing strip running around the periphery of the opening. Alternatively, the seal mounting frame can also only partially border the opening. The seal mounting frame thus does not have to be completely closed and instead can also form only a frame section on which the seal can be fastened or by means of which the seal can be formed.

In a further aspect, it is proposed that the seal mounting frame has at least one attachment profile on which the at least one seal is arranged, in particular by being pushed on or adhesively bonded.

The geometric form of such an attachment profile can in principle be designed in any desired fashion. Such an attachment profile can have, for example, a hook or a projection and/or a recess, in particular in the form of a groove. The seal can be fastened on the attachment profile by being pushed in or pushed on or inserted or plugged on or adhesively bonded. The free choice of the geometry of the attachment profile makes the use of a wide range of seal geometries possible.

In a further aspect, it is proposed that the seal mounting frame forms a nozzle duct of the cleaning nozzle and an in particular slit-shaped nozzle discharge opening of the cleaning nozzle. In an alternative embodiment, the cleaning nozzle can also be formed by an insert which can then form such a nozzle duct and such a nozzle discharge opening.

The nozzle discharge opening is preferably oriented in such a way that it is possible to apply the cleaning fluid directly to the see-through area. A main direction of the nozzle discharge opening is here preferably oriented in the direction of the see-through area.

The nozzle discharge opening preferably extends parallel or substantially parallel to the see-through area. The nozzle discharge opening is preferably oriented in terms of its longitudinal extent on a longitudinal extent of the see-through area such that the cleaning fluid can be applied to the whole surface of the see-through area or at least within a field of view of the environment sensor.

In a further aspect, it is proposed that the seal mounting frame has a mounting section for attachment to the surface component, and wherein the seal mounting frame preferably has at least one further attachment profile on which can be arranged a surface-component seal for sealing an intermediate space between the surface component and the seal mounting frame.

A further attachment profile or an additional seal geometry can thus be provided in order to provide a seal between the seal mounting frame into which the cleaning nozzle can be integrated and the surface component or another body part of the motor vehicle. In a further aspect, it is proposed that the sensor module has two seals, wherein the seal mounting frame has two attachment profiles, in particular situated opposite each other, on which in each case one of the two seals is arranged, wherein the seal mounting frame is arranged in the intermediate space, and wherein one of the two seals is formed for providing a seal between the opening and the seal mounting frame, and wherein the other of the two seals is formed for providing a seal between the seal mounting frame and the sensor housing.

The degree of design freedom can be increased as a result. Moreover, the cleaning nozzle can be arranged even closer to the see-through area. In this embodiment, the seal mounting frame is preferably arranged on a sensor module frame or a body part of the motor vehicle. However, arrangement on the surface component is also possible and can be advantageous from a space and structural point of view.

In a further aspect, it is proposed that the cleaning nozzle is oriented parallel to or angled with respect to the surface component.

The cleaning nozzle or the relevant part of the seal mounting frame, when the cleaning nozzle is formed integrally by the seal mounting frame, can preferably be angled relative to the surface component or can protrude from the latter. As a result, less space is required in a vehicle longitudinal direction. The cleaning nozzle or the relevant part of the seal mounting frame, when the cleaning nozzle is formed integrally by the seal mounting frame, can preferably be oriented parallel relative to the surface component. As a result, less space is required in a vehicle vertical direction.

In the present document, a vehicle roof of a motor vehicle comprising at least one sensor module according to any embodiment is also claimed.

A preferred embodiment of the vehicle roof is designed as a roof sensor module. Such a roof sensor module integrally forms a structural unit which accommodates components which are required for self-driving or partial self-driving of the relevant vehicle. The roof sensor module into which a plurality of functional elements can thus be integrated hence constitutes a compact structural unit which is connected by a vehicle manufacturer to a vehicle body or a vehicle bodyshell which comprises roof posts such as roof side posts and/or roof longitudinal posts. The vehicle roof designed as a roof sensor module thus constitutes a roof sensor module (RSM) which makes self-driving or partial self-driving of the relevant vehicle possible.

A motor vehicle which is equipped with such a vehicle roof and takes the form of a self-driving vehicle drives in self-driving mode independently at least without significant intervention by a driver. In partial self-driving mode, the vehicle roof according to the invention forms, for example, part of a driver assistance system.

The vehicle roof can be provided with a transparent fixed roof section and/or a roof opening system for a roof opening.

In particular, the vehicle roof forms at least part of a roof of a car. It can, however, also be a roof of a commercial vehicle which takes the form, for example, of a delivery truck, a bus, a self-driving minibus such as a so-called people mover, or also the form of a truck traction unit.

A motor vehicle is also claimed in the present document which comprises a sensor module and/or a vehicle roof of the above-described type. The vehicle roof preferably forms a roof sensor module (RSM) which can be arranged as a pre-assembled structural unit on a vehicle body of the motor vehicle. In other words, in particular a vehicle bodyshell of the motor vehicle can thus be provided with a prefabricated or pre-assembled roof sensor module which is designed as a roof sensor module.

It should be understood that the embodiments and exemplary embodiments which are mentioned above and are to be explained below can be formed not only individually but also in any desired combination without going beyond the scope of the present invention. It should also be understood that the embodiments and exemplary embodiments which are mentioned above and are to be explained below relate in an equivalent or at least similar fashion to all embodiments of the invention without being mentioned separately in each case.

### BRIEF DESCRIPTION OF DRAWINGS

Embodiments of the invention are illustrated schematically in the drawings and are explained below by way of example.

FIG. 1 shows a schematic view of a vehicle roof with a sensor module.

FIG. 2 shows an exemplary embodiment of a sensor module.

FIG. 3 shows an exemplary embodiment of a sensor module.

FIG. 4 shows an exemplary embodiment of a sensor module.

FIG. 5 shows an exemplary embodiment of a sensor module.

FIG. 6 shows an exemplary embodiment of a sensor module.

FIG. 7 shows an exemplary embodiment of a sensor module.

### DETAILED DESCRIPTION

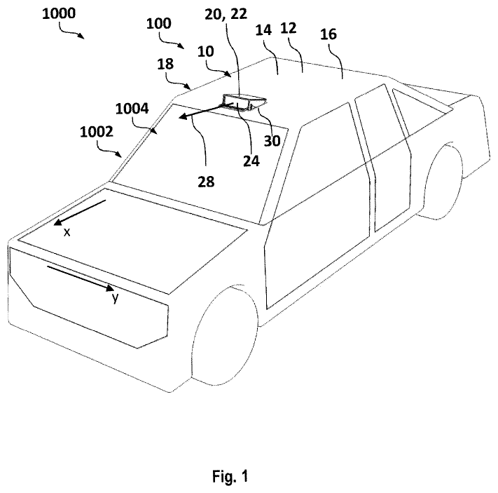

FIG. 1 shows schematically a motor vehicle 1000 which has a vehicle body 1002. The motor vehicle 1000 moreover has a roof sensor module 10 which is arranged as a pre-assembled structural unit on the vehicle body 1002 and forms a vehicle roof 100 of the motor vehicle 1000 at least in some sections. The motor vehicle 1000 has a windshield. In alternative embodiments, the vehicle roof 100 can also be a vehicle roof which is not designed as a roof sensor module. All the embodiments thus also relate to such a vehicle roof 100.

The roof sensor module 10 comprises a surface component 12 which forms a roof skin 14 of the vehicle roof 100 at least in some regions. The roof sensor module 10 comprises according to FIG. 1 a fixed roof element 16. In other or supplementary embodiments, the roof sensor module 10 can have a roof opening system which comprises a lid element which can be shifted to selectively open or close a roof opening.

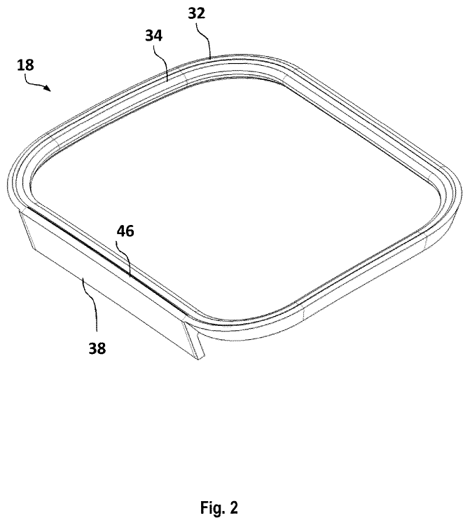

The motor vehicle 1000 has a sensor module 18 which in the present case is part of the roof module 10. The surface component 12 is in the present case part of the sensor module 18. The sensor module 18 has a cover 20. The sensor module 18 moreover has at least one environment sensor 22 for capturing a vehicle environment. The environment sensor 22 is arranged on a sensor module frame (not shown). The environment sensor 22 is configured to capture the vehicle environment via a see-through area 24. The see-through area 24 is provided according to FIG. 2 as a window in an opening (not shown in detail) of a sensor housing 26. The see-through area 24 can be provided integrally in the sensor housing 26 or be arranged separately in the latter. The cover 20 is in the present case part of the sensor housing 26.

The environment sensor 22 can be a lidar sensor and/or a camera and/or a radar sensor and/or an ultrasound sensor and/or a multi-camera sensor. Other sensors are also conceivable. The environment sensor 22 is arranged in the sensor housing 26. The environment sensor 22 has an optical axis 28 which defines a main capturing direction of the environment sensor 22. The optical axis 28 (viewing direction) is in the present case oriented parallel to a vehicle longitudinal direction x. The vehicle longitudinal direction x is orthogonal to a vehicle width direction y.

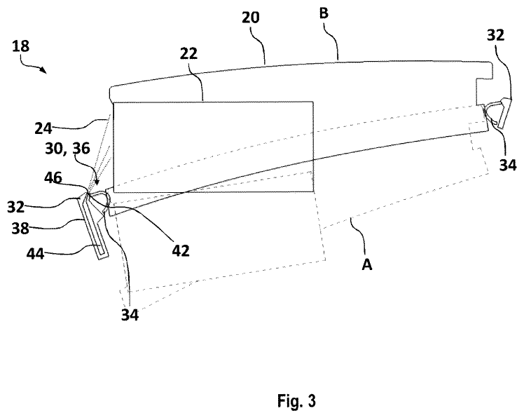

The sensor housing 26, together with the environment sensor 22 comprised therein, is arranged in an opening 30 in the surface component 12 and can be adjusted between a retracted position A (in dashed lines in each case in FIGS. 3, 5, and 6) and an extended position B. The adjustability is provided by a movement mechanism (not shown in detail) which can take the form of a lever mechanism or a linear-drive mechanism. Such a lever mechanism can take the form of a multi-articulated mechanism and have a plurality of levers or links in order to adjust the sensor housing 26 between a retracted position A and an extended position B and possibly further intermediate positions.

The sensor module 18 moreover has a seal mounting frame 32 which is arranged in the region of the opening 30. The sensor module 18 moreover has at least one seal 34 which is arranged on the seal mounting frame 32 or is formed by the latter. An intermediate space 36 between the opening 30 and the sensor housing 26 can be sealed by the at least one seal 34.

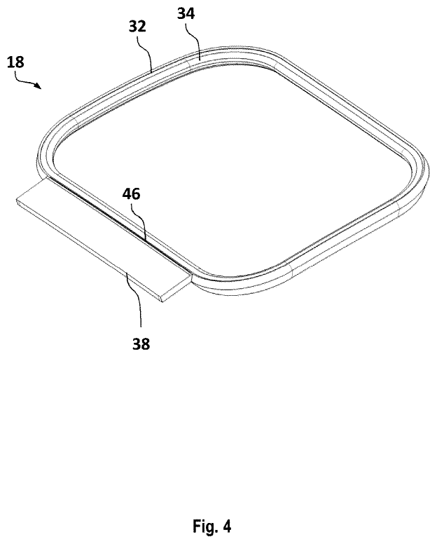

The seal mounting frame 32 has a cleaning nozzle 38 for cleaning the see-through area 24 at least in some sections. The seal mounting frame 32 forms the cleaning nozzle 38, in particular integrally, at least in some sections (see FIGS. 2 and 4). Alternatively, the cleaning nozzle 38 can also be formed by an insert (not shown) which can be arranged on the seal mounting frame 32 at least in some sections or can be inserted or pushed into the latter. The seal mounting frame 32 in the present case borders an edge region 40 of the opening 30 at least in some sections, in the present case completely. The seal mounting frame 32 in the present case takes the form of a closed frame which in the example of FIGS. 2 and 4 carries the seal 34 which can be formed as a sealing strip running around the periphery of the seal mounting frame 32.

The seal mounting frame 32 can have at least one attachment profile 42 on which the at least one seal 34 is arranged, in particular by being pushed on or adhesively bonded. The seal mounting frame 32 can form a nozzle duct 44 of the cleaning nozzle 38 and an in particular slit-shaped nozzle discharge opening 46 of the cleaning nozzle 38. The seal mounting frame 32 can also form or hold further components of a cleaning device, for example a feed line and/or a retaining means for fluid lines.

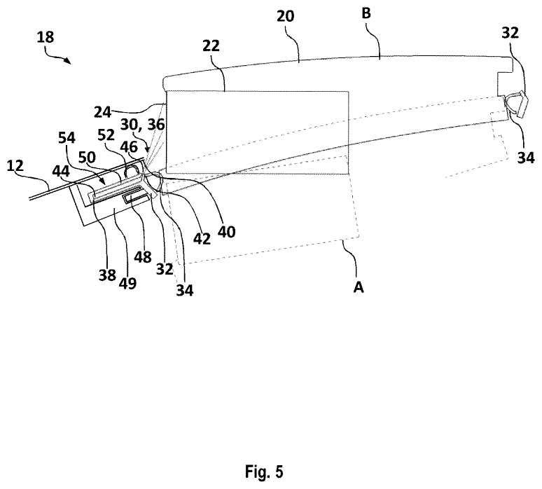

The seal mounting frame 32 can moreover have a mounting section 48 for attachment to the surface component 12, for example via a corresponding mating mounting profile 49, or to a sensor module frame or another body part. The seal mounting frame 32 can preferably have at least one further attachment profile 50 on which a surface-component seal 52 for sealing an intermediate space 54 between the surface component 12 and the seal mounting frame 32 can be arranged (see FIG. 5).

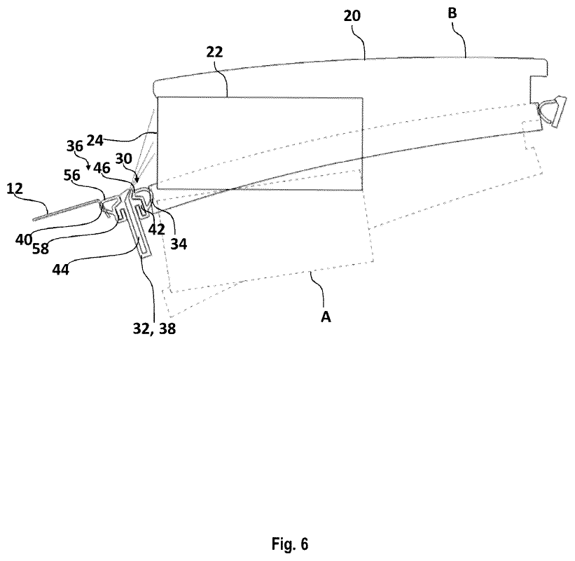

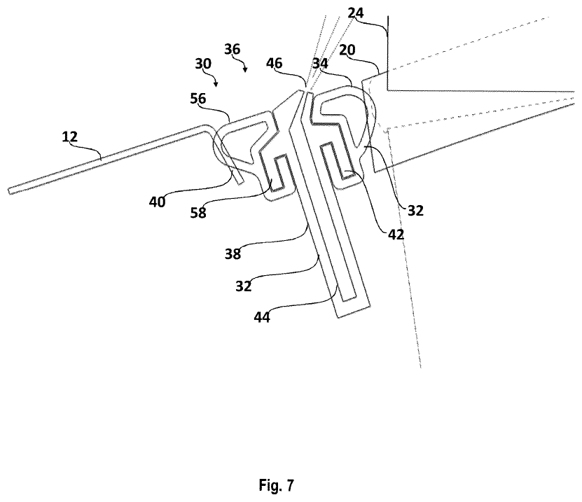

As is apparent from FIG. 6 and in detail from FIG. 7, the sensor module 18 can also have two seals 34, 56, wherein the seal mounting frame 32 has two attachment profiles 42, 58, in particular situated opposite each other, on which in each case one of the two seals 34, 56 is arranged. The seal mounting frame 32 is here arranged in the intermediate space 36. One of the two seals 56 is formed for providing a seal between the opening 30 or the edge region 40 and the seal mounting frame 32. The other of the two seals 34 is formed for providing a seal between the seal mounting frame 32 and the sensor housing 26. According to FIGS. 6 and 7, the attachment profiles 42, 58 are formed with a hook shape. The seals 34 and 56 are in each case pushed or adhesively bonded onto these attachment profiles 42, 58.

### LIST OF REFERENCE SIGNS

10 roof sensor module
12 surface component
14 roof skin
16 fixed roof element
18 sensor module
20 cover
22 environment sensor
24 see-through area
26 sensor housing
28 optical axis
30 opening
32 seal mounting frame
34 seal
36 intermediate space
38 cleaning nozzle
40 edge region
42 attachment profile
44 nozzle duct
46 nozzle discharge opening
48 mounting section
49 mating mounting profile
50 attachment profile
52 surface-component seal
54 intermediate space
56 seal
58 attachment profile
100 vehicle roof
1000 motor vehicle
1002 vehicle body
A retracted position
B extended position
x vehicle longitudinal direction
y vehicle width direction

1. A sensor module for a motor vehicle having: a surface component with an opening; a sensor housing with a see-through area which is arranged in the opening so that it can be adjusted between a retracted position and an extended position; an environment sensor which can capture a vehicle environment through the see-through area at least in the extended position, and which is arranged in the sensor housing; a seal mounting frame which is arranged in the region of the opening; at least one seal which is arranged on the seal mounting frame or is formed by the seal mounting frame, and by means of which an intermediate space between the opening and the sensor housing can be sealed, wherein the seal mounting frame has at least in some sections a cleaning nozzle for cleaning the see-through area.

2. The sensor module as claimed in claim 1, wherein the seal mounting frame forms the cleaning nozzle at least in some sections, or wherein the cleaning nozzle is formed by an insert which is arranged or inserted or pushed in at least in some sections on the seal mounting frame.

3. The sensor module as claimed in claim 1, wherein the seal mounting frame borders an edge region of the opening at least in some sections.

4. The sensor module as claimed in claim 1, wherein the seal mounting frame has at least one attachment profile on which the at least one seal is arranged.

5. The sensor module as claimed in claim 1, wherein the seal mounting frame forms a nozzle duct of the cleaning nozzle.

6. The sensor module as claimed in claim 1, wherein the seal mounting frame has a mounting section for attachment to the surface component.

7. The sensor module as claimed in claim 4, wherein the sensor module has two seals, wherein the seal mounting frame has two attachment profiles, in particular situated opposite each other, on which in each case one of the two seals is arranged, wherein the seal mounting frame is arranged in the intermediate space, and wherein one of the two seals is formed for providing a seal between the opening and the seal mounting frame, and wherein the other of the two seals is formed for providing a seal between the seal mounting frame and the sensor housing.

8. The sensor module as claimed in claim 1, wherein the cleaning nozzle is oriented parallel to or angled with respect to the surface component.

9. A vehicle roof of a motor vehicle, comprising at least one sensor module as claimed claim 1.

10. A motor vehicle, comprising a sensor module as claimed in claim 1, and a vehicle roof, wherein the vehicle roof forms a roof sensor module which can be arranged as a pre-assembled structural unit on a vehicle body of the motor vehicle.

11. The sensor module as claimed in claim 1, wherein the seal mounting frame forms the cleaning nozzle at least in some sections integrally,

12. The sensor module as claimed in claim 1, wherein the seal mounting frame completely borders an edge region of the opening at least in some sections.

13. The sensor module as claimed in claim 1, wherein the seal mounting frame has at least one attachment profile on which the at least one seal is arranged by being pushed in or adhesively bonded.

14. The sensor module as claimed in claim 1, wherein the seal mounting frame forms a slit-shaped nozzle discharge opening of the cleaning nozzle.

15. The sensor module as claimed in claim 6, wherein the seal mounting frame has at least one further attachment profile on which can be arranged a surface-component seal for sealing an intermediate space between the surface component and the seal mounting frame.

16. The sensor module as claimed in claim 7, wherein the two attachment profiles are situated opposite each other.

17. A motor vehicle, comprising a vehicle roof as claimed in claim 9, wherein the vehicle roof forms a roof sensor module which can be arranged as a pre-assembled structural unit on a vehicle body of the motor vehicle.
